(19) United States
(12) Patent Application Publication
(10) Pub. No.: US 2019/0024413 A1
(43) Pub. Date: Jan. 24, 2019

(54) ELECTRONIC CABINET LOCK AND CONTROL METHOD

(71) Applicant: WUHAN PULINGUANGTONG TECHNOLOGY CO.,LTD., Wuhan, Hubei province (CN)

(72) Inventors: Zhiguo XU, Wuhan, Hubei province (CN); Jia LI, Wuhan, Hubei province (CN); Jingwu WANG, Wuhan, Hubei province (CN)

(73) Assignee: WUHAN PULINGUANGTONG TECHNOLOGY CO.,LTD., Wuhan, Hubei province (CN)

(21) Appl. No.: 16/071,965

(22) PCT Filed: Nov. 21, 2016
(86) PCT No.: PCT/CN2016/106645

§ 371 Date: Jul. 23, 2018

(30) Foreign Application Priority Data
Jan. 24, 2016 (CN) 201610043462.0

(51) Int. Cl. E05B 47/02; E05B 3/00; E05B 65/52; E05B 47/00

(52) U.S. Cl. CPC E05B 47/02; E05B 3/00; E05B 2047/0094; E05B 47/0005; E05B 65/52

(57) ABSTRACT

An electronic cabinet lock comprises a lock body base (101) and a handle (201), one end of the handle is movably connected with the lock body base, and the other end is attached with an unlocking mechanism and a engaging board (204), a self-holding electromagnet is attached on the lock body base, the self-holding electromagnet comprises an electromagnetic coil (301), a retractable body (302), a first permanent magnet (303), and a biasing structure body (304), when the electromagnetic coil (301) is energized forwardly, the retractable body (302) can be driven to perform a retracting operation, when the electromagnetic coil (301) is energized reversely, the retractable body (302) can be driven to perform an extending operation, a mutual snap-fit between the retractable body (302) and the engaging board (204) is realized and released by relative movement of the retractable body (302) and the engaging board (204) in the retractable direction and the permanent magnet (303) is mounted on an outer side of the hole for movement of the retractable body (302), in order to maintain the retracting state when the retractable body (302) retracts, the biasing structure body applies force to the retractable body (302), in order to maintain the extending state when the retractable body (302) extends. Also disclosed is a control method of the electronic cabinet lock for controlling the electronic cabinet lock.

### FIELD OF TECHNOLOGY

The present disclosure relates to an electronic lock, in particular relates to an electronic cabinet lock and a control method thereof.

### BACKGROUND ART

With the vigorous development of information technology, outdoor cabinets are replacing the traditional equipment rooms due to their little space taking, easy installation, uniform specifications and high protection performance, and becoming preferred necessary facilities in laying of wireless base stations and monitoring equipments. However, the traditional outdoor cabinets are often only equipped with mechanical cabinet locks, which cannot meet the requirements for access control after informationization. China Tower Group currently proposes a brand-new cabinet access solution that requires the electronic cabinet lock to be remotely opened. The mechanical keys are only usable when malfunction occurs in the access control system, such as power outages, network outages, equipment failure, etc., in this way the risks of the mechanical keys such as easy to copy, difficult to manage can be avoided. The traditional electronic cabinet locks, due to structure constraints of the lock body, is still unable to fully meet the proposed requirements.

### DESCRIPTION

In order to overcome the above shortcomings, the object of the present disclosure is to provide an electronic cabinet lock and a control method thereof to the art, so as to solve the above technical problems that cannot be satisfied by the existing locks. Its object is achieved through the following solution.

An electronic cabinet lock, comprising a lock body base, a handle, an unlocking mechanism, an engaging board, a self-holding electromagnet, one end of the handle is movably connected to the lock body base, the other end of the handle is attached with the unlocking mechanism and the engaging board which moves under control of the unlocking mechanism, a self-holding electromagnet is attached on the lock body base, the self-holding electromagnet comprises an electromagnetic coil, a retractable body, a first permanent magnet, and a biasing structure body, the retractable body is disposed in a hole for movement of the retractable body of the electromagnetic coil, when the electromagnetic coil is energized forwardly, the retractable body can be driven to perform a retracting operation or the biasing structure body can be driven to drive the retractable body to perform a retracting operation, when the electromagnetic coil is energized reversely, the retractable body can be driven to perform an extending operation or the retractable body can be driven by the electromagnetic coil and the biasing structure body to perform an extending operation, when the electromagnetic coil is de-energized, the retractable body remains in an extending state or a retracting state, the engaging board is controlled by the unlocking mechanism to move in a retractable direction of the retractable body, a mutual snap-fit between the retractable body and the engaging board is realized by movement of the retractable body and the engaging board towards each other in the retractable direction and is released by movement of the retractable body and the engaging board away from each other in the retractable direction, the first permanent magnet is mounted on an outer side of the hole for movement of the retractable body (e.g. an outer wall of the hole for movement of the retractable body), in order to maintain the retracting state when the retractable body retracts, the biasing structure body bias the retractable body, in order to maintain the extending state when the retractable body extends.

With the above configuration, according to the present disclosure, when the electronic cabinet lock is in a closed state, the retractable body in the extending state and the engaging board on the handle mutually snap-fit with each other, and the handle is kept to be in a state of being closed in the lock body base; when performing automatic unlocking (electrically controlled unlocking), the electromagnetic coil is energized forwardly, driving the retractable body to perform a retracting operation, so as to be disengaged from the engaging board and the handle is opened.

In addition, when the electronic cabinet lock is in the closed state, if the unlocking mechanism is manually operated, the unlocking mechanism moves the engaging board towards the retracting direction of the retractable body and drives the retractable body to move and thus retract, and then the engaging board performs a returning movement towards the extending direction of the retractable body. At this time, there are two situations, one is that, if the electromagnetic coil is de-energized or energized forwardly, the retractable body is held in the retracting state through the first permanent magnet and released from the snap-fitting state with the engaging board when the engaging board returns towards the extending direction of the retractable body, the handle is detached from the lock body base, the electronic cabinet lock is opened; the other is that, if the electromagnetic coil remains being energized reversely, the retractable body extends when the engaging board performs a returning movement, and follows the movement of the engaging board to maintain the snap-fitting state between both. The handle is still closed in the lock body base, and the electronic cabinet lock cannot be opened.

It can be seen, with the present disclosure, as long as the electromagnetic coil is always energized reversely when the electronic cabinet lock is in a closed state, the purpose of preventing illegal unlocking can be achieved. Specifically, for example, when the electromagnetic coil is not de-energized, the electromagnetic coil remains being energized reversely when the electronic cabinet lock is in a closed state, and the snap-fitting state between the retractable body and the engaging board cannot be released by the unlocking mechanism, and unlocking cannot be achieved; while when the electromagnetic coil is de-energized, the retractable body is held in the retracting position by the first permanent magnet when the retractable body retracts, and thus the unlocking mechanism can be used to release the snap-fitting state between the retractable body and the engaging board, and unlocking can be achieved.

In addition, the self-holding electromagnet means the state of the electromagnet can be maintained in a power-off state.

The unlocking mechanism is a mechanical unlocking key, a lock core, a knob or a button; and the movement of the engaging board controlled by the unlocking mechanism refers to up and down movement of the engaging board controlled by the unlocking operation of the mechanical unlocking key, the lock core, the knob, or the button.

The lock core may be a pure mechanical lock core without an internal relevant electric control structure; or an electronic lock core with an internal chip, the electronic lock core may have an electric control structure of an electromagnet or a motor etc, and such structure can be completely independent from the other structures inside the lock body, that is, when the electric control part (electromagnetic coil) inside the lock body listed in the present technical solution fails, the electronic lock core will still maintain its own independent running state.

The biasing structure body is a retractable body spring or a second permanent magnet; in a case where the biasing structure body connecting with the retractable body is a retractable body spring connecting with the retractable body, the retractable body spring exerts a downward force on the retractable body when the retractable body is in the retracting state, in this case, the retractable body is made of a material (typically, iron) which can be magnetically attracted and can be directly attracted by the magnetic force of the first permanent magnet; in a case where the biasing structure body connecting with the retractable body is the second permanent magnet attached on the retractable body, the second permanent magnet repels the magnetism of the first permanent magnet when the retractable body is in the extending state, maintaining the retractable body in the extending state, while as the retractable body moves upward to a retracting state, the second permanent magnet generates a magnetic attractive force to the first permanent magnet with displacement relative to the first permanent magnet, so as to keep the retractable body in a retracting state.

The electronic cabinet lock further comprises a return tongue and a return spring which are mounted in the lock body base, a lower end of the return tongue abuts against an outer wall of the handle or engaging board, when the handle is closed in the lock body base, the return spring is compressed or stretched; the return tongue cooperates with the retractable body, and when the retractable body is in a high position and the handle is detached from the lock body base, the return spring pushes the return tongue to cause the retractable body to move downward. For the setting of the return spring, it may be a compression spring as in embodiments, however, undeniably the extension spring may also be provided as long as the return tongue can be pushed to cause the retractable body to perform a downward return movement.

The electronic cabinet lock further comprises an inductive switch attached in the lock body base for sensing the unlocking operation performed by using the unlocking mechanism; the inductive switch is a tact switch, an electromagnetic inductive switch, a contact switch, or a microswitch; the inductive switch is configured to sense the unlocking operation performed by using the unlocking mechanism, which means that said inductive switch senses lifting movement of the engaging board, or senses upward movement of the retractable body, or senses upward movement of the return tongue pushed by the engaging board, or senses motion occurs when inserting the unlocking key, turning the lock core or knob of the handle or pushing down the button.

The electronic cabinet lock further comprises a control circuit board, the control circuit board is connected with an electromagnetic coil to energize the electromagnetic coil forwardly or reversely, and the control circuit board is connected with an inductive switch to receive inductive signal from the inductive switch. The control circuit board determines whether or not the operation of the unlocking mechanism is an illegal unlocking operation when the mechanical unlocking machine is actuated to trigger the inductive switch, and if it is determined that the unlocking operation is an illegal unlocking operation, the electromagnetic coil is energized reversely, if it is determined that the unlocking operation is a legal unlocking operation, the electromagnetic coil is energized forwardly or de-energized.

In order to achieve a snap-fitting structure, the present disclosure can employ the following structure: an upper end of the engaging board is provided with an engaging boss fitting with the retractable body, and when the electronic cabinet lock is in a closed state, a lower end of the retractable body in the extending state falls on the engaging boss and is supported thereon, and mutually snap-fits with the engaging boss. In addition, undeniably, other structures can also be used.

An electronic cabinet lock control method, wherein the electromagnetic coil remains being energized reversely when the electronic cabinet lock is in a closed state; the electromagnetic coil of the self-holding electromagnet is energized forwardly when there is a need of automatic unlocking.

At this time, the action of the electronic cabinet lock is as follows:

In the initial state, the electromagnet coil keeps energized reversely, the electromagnet coil, the first permanent magnet and the biasing structure body conjointly hold a downward force on the retractable body which remains in an extending state, the retractable body and the engaging board are snap-fitted mutually, the control handle is closed in the lock body base, and the electronic cabinet lock is in a closed state;

when the automatic unlocking is needed, the electromagnet coil of the self-holding electromagnet is energized forwardly, and the electromagnetic force generated by the electromagnet coil on the retractable body or the biasing structure body located on the retractable body causes the retractable body to move upwards, the retractable body and the engaging board are released from the snap-fitting state, the handle is detached from the lock body base and the electronic cabinet lock is automatically opened;

when the engaging board is moved upward by the unlocking mechanism, the retractable body is pushed to move upward, and the retractable body is transformed from the extending state to the retracting state.

if the electromagnet coil is de-energized or energized forwardly, the retractable body is kept in the retracting state and released from the snap-fitting state by the action of the permanent magnet when the engaging board moves downward, and the handle is detached from the lock body base, and the electronic cabinet lock is opened;

If the electromagnet coil still keeps being energized reversely, the electromagnet coil, the first permanent magnet and the biasing structure body conjointly hold a downward force on the retractable body, when the engaging board moves downward, the retractable body moves downward with the engaging board and remains in a snap-fitting state, the handle is still closed in the lock body base, and the electronic cabinet lock cannot be opened;

Therefore, with the present disclosure, as long as the electromagnetic coil is always energized reversely when the electronic cabinet lock is in a closed state, the purpose of preventing illegal unlocking can be achieved.

When the electronic cabinet lock has the return tongue and the return spring, the action thereof is as follows:

After/when the handle is detached from the lock body base, the lower end of the return tongue is detached from the outer wall of the handle or the engaging board, the return tongue is pushed by the compressed return spring to perform a downward movement, the return tongue pushes the retractable body in the retracting state to move downward against the magnetic force of the first permanent magnet, the retractable body extends and remains in an extending state;

when the state of electronic cabinet lock is changed from “opened” to “closed”, the handle is pushed into the lock body base, the outer wall of the handle or the engaging board pushes the return tongue to move upward and the return spring is compressed, and the retractable body is held in the extending state by the biasing structural body and snap-fits with the engaging board, the electronic cabinet lock is closed.

The disclosure also relates to an electronic cabinet lock control method, the electromagnetic coil remains being energized reversely when the electronic cabinet lock is in a closed state; the electromagnetic coil of the self-holding electromagnet is energized forwardly when there is a need of automatic unlocking; in a case where the electronic cabinet lock is in a closed state, when the engaging board moves upward through the unlocking mechanism, the inductive switch is triggered, in this case it is determined whether the action of the unlocking mechanism is an illegal unlocking operation, if it is determined that the action is a legal unlocking operation, the electromagnetic coil is energized forwardly or de-energized when the engaging board moves downward; if it is determined that the action is an illegal unlocking operation, the electromagnetic coil is energized reversely or maintains being energized reversely. The legal unlocking operation, for instance, comprises unlocking operation performed by the unlocking mechanism when a network interruption or equipment malfunction occurs, or when the electronic cabinet lock obtains a legal unlocking authorization.

The “electronic cabinet lock obtains a legal unlocking authorization” refers to the case where the electronic cabinet lock may also obtain “a unlocking authorization” before it is triggered by the “unlocking mechanism”.

The action of the electronic cabinet lock is as follows:

when the engaging board is moved upward by the unlocking mechanism, the retractable body is pushed to move upward, and the retractable body is transformed from the extending state to the retracting state; at this time the inductive switch is triggered;

if the electromagnet coil is de-energized when it is determined that it is a legal unlocking operation or malfunction occurs in control of the electronic cabinet lock, or due to the electronic cabinet lock failure itself, the retractable body is kept in the retracting state and released from the snap-fitting state with the engaging board by the action of the permanent magnet when the engaging board moves downward, and the handle is detached from the lock body base, and the electronic cabinet lock is opened;

If it is determined that it is an illegal unlocking operation, the electromagnet coil is energized reversely or keeps being energized reversely, the electromagnet coil, the first permanent magnet and the biasing structure body then conjointly hold a downward force on the retractable body, when the engaging board moves downward, the retractable body moves downward with the engaging board and remains in a snap-fitting state, the handle is still closed in the lock body base, and the electronic cabinet lock cannot be opened.

It can be seen from the above that by adopting the present disclosure, the unlocking mechanism can also be used for unlocking when the network is interrupted, the equipment malfunction occurs and the like, besides the power-off case.

The present disclosure provides an electronic cabinet lock and a control method thereof, of which the electronic cabinet lock has simple and reliable structure and the principle of the control method is clear. The disclosure utilizes the self-holding electromagnet with the characteristics of maintaining the state of the retractable body after power-off, and the cooperation between the retractable body and the engaging board to achieve the object of a new electronic cabinet lock that the electronic lock can be automatically opened daily without any tools, and the mechanical key can only be used for unlocking in the event of lock malfunction, through reasonable and ingenious structure design, the current technical requirements for the electronic lock can be fully met, and the present disclosure has a high promotional value.

### BRIEF DESCRIPTION OF THE DRAWINGS

FIG. 1 is a schematic exploded view of an electronic cabinet lock of the present disclosure;

FIG. 2 is an internal schematic view of the electronic cabinet lock in the present disclosure when the electronic cabinet lock is in a locked state;

FIG. 3 is an enlarged schematic view of part A of FIG. 2;

FIG. 4 is a schematic sectional view of the electronic cabinet lock in the present disclosure when the electronic cabinet lock is in a locked state;

FIG. 5 is a schematic sectional view of the electronic cabinet lock in the present disclosure when the state of the electronic cabinet lock is changed from a closed state to a unlocked state;

FIG. 6 is a partial internal schematic view of the electronic cabinet lock in the present disclosure when the bearing 302 is pushed into a retracting state;

FIG. 7 is an internal schematic view of the electronic cabinet lock in the present disclosure after the handle of the electronic cabinet lock is detached from the lock body base.

### DESCRIPTION OF THE SYMBOLS

101 lock body base, 102 position-limiting hole, 103 electronic box, 201 handle, 202 lock core, 203 mechanical key, 204 engaging board, 205 engaging boss, 206 slot, 301 electromagnetic coil, 302 bearing (retractable body), 303 permanent magnet (a first permanent magnet), 304 bearing spring (retractable body spring, retractable body biasing spring), 305 retaining ring, 306 triggering lever, 401 control circuit board, 402 tact switch, 403 contact spring, 501 return tongue, 502 return spring, 503 engaging block.

### DETAILED DESCRIPTION

The technical solutions in the embodiments of the present disclosure will be described clearly and completely hereafter with reference to the accompanying drawings. Apparently, the described embodiments are only a part of but not all embodiments of the present disclosure. All other embodiments obtained by persons of ordinary skill in the art based on the embodiments of the present disclosure without creative efforts shall fall within the protection scope of the present disclosure.

In the following description, “upward” movement and “downward” movement, “trigger” and “release triggering”, “energized forwardly” and “energized reversely” are only in relative terms. It can be understood that, without changing the principle of the control method of the electronic lock, the “upward” movement may also be changed to “downward” movement, the “trigger” may also be changed to “untrigger” or “release triggering”, the “energized forwardly” electromagnetic coil can also become the “energized reversely” electromagnetic coil, of which the state and manner are only relative terms, and the control method of the electronic lock has not been actually changed. This should belong to the scope of the present disclosure.

To facilitate understanding the content of the present disclosure, an electronic lock used in industrial sites will be described below. It can be understood that the electronic cabinet lock and the control method thereof according to the present disclosure are not limited to such locks, and can meet the demands even in more applications where electronic cabinet locks are used. This should not be taken as a limitation on the present disclosure, but should all fall within the protection scope of the present disclosure.

### Embodiment 1: An Electronic Cabinet Lock

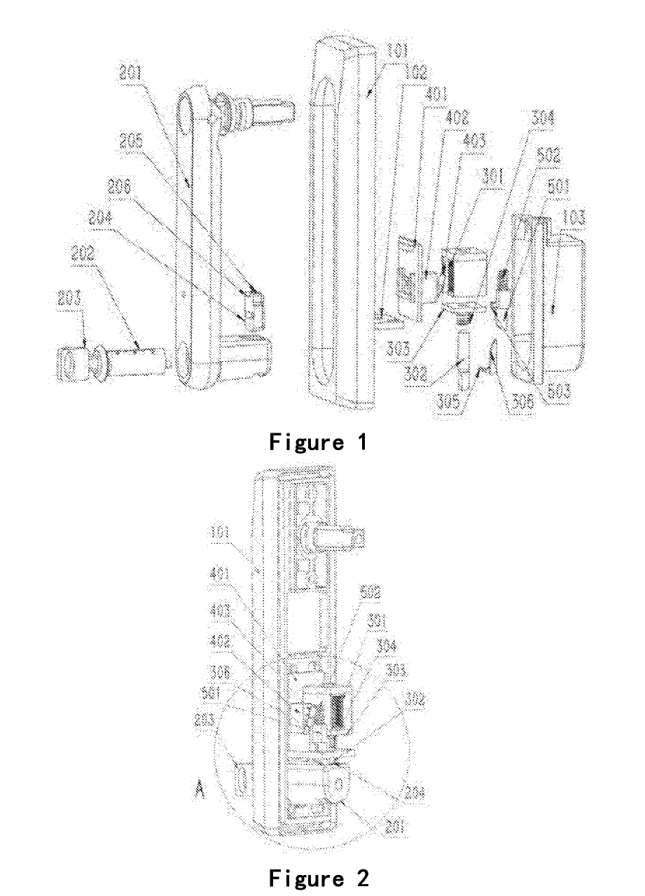

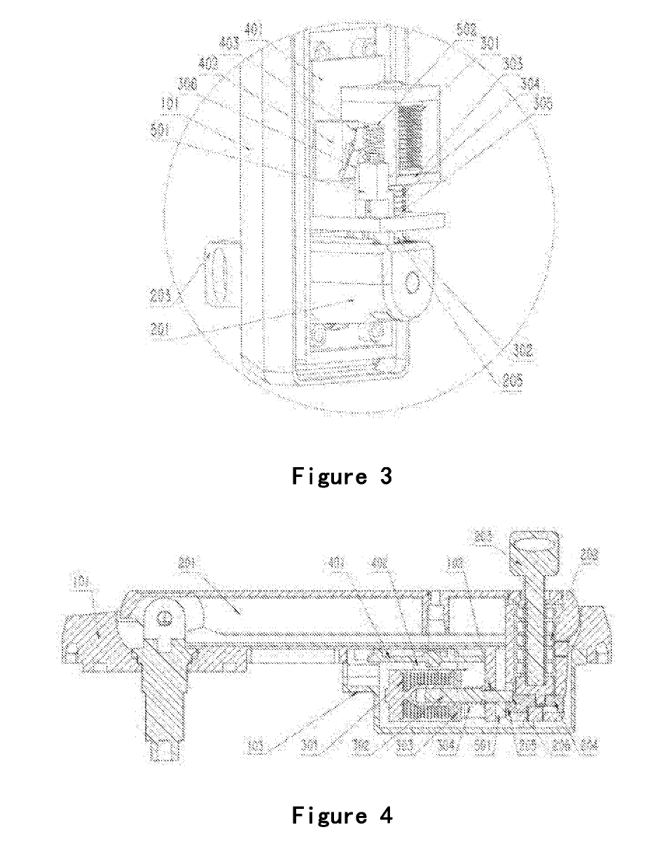

FIG. 1 is a schematic exploded view of the electronic cabinet lock; FIG. 2 is an internal schematic view of the electronic cabinet lock in the present disclosure when the electronic cabinet lock is in a locked state; FIG. 3 is an enlarged schematic view of part A of FIG. 2; FIG. 4 is an internal schematic sectional view of the electronic cabinet lock in the present disclosure when the electronic cabinet lock is in a locked state. As can be seen from the figures, the electronic cabinet lock is composed of a lock body base 101 and a handle 201 with an upper end movably connected with the lock body base 101; wherein a lock hole at a lower end of the handle 201 is provided with a mechanical lock core 202. The mechanical lock core 202 can be rotated and unlocked under control of a mechanical key 203. A rear end of the mechanical lock core 202 is connected with a engaging board 204 that can move up and down; an upper end of the engaging board 204 has an engaging boss 205, and a concave slot 206 is provided in the middle of the engaging boss 205. A detachable electronic box 103 is provided on the back of the lock body base 101. An electromagnet having a self-holding function is mounted inside the electronic box 103. The electromagnet consists of a electromagnetic coil 301, a permanent magnet 303 (sometimes also referred as a first permanent magnet 303), a bearing 302 (a retractable body) and a bearing spring 304 (retractable body spring and retractable body biasing spring), wherein the permanent magnet 303 is located under the electromagnetic coil 301, the bearing 302 is located in the bearing hole 302 in the electromagnetic coil 301, the bearing spring 304 is located between the permanent magnet 303 and the ring 305 on the bearing 302; when the electronic cabinet lock is in a locked state, the bearing 302 protrudes with its lower end falls right in a slot 206 and engages with the engaging boss 205 and locks the handle 201.

It can be understood that the unlocking structure (unlocking mechanism) shown in the figures is a mechanical key 203 and a lock core 202 for controlling the function of the engaging board 204 for the upward/downward movement. The engaging board 204 may also be controlled by knobs mounted on the handle 201, or buttons, or directly controlled by mechanical unlocking keys. For this respect, all other implementation ways of the unlocking structure obtained by persons of ordinary skill in the art without creative efforts shall fall within the protection scope of the present disclosure.

It can be seen that the electronic cabinet lock shown in the figures further includes a return tongue 501 and a return spring 502 installed in the lock body base 101. When the handle 201 is closed in the lock body base 101, the lower end of the return tongue 501 abuts against the outer wall of the handle 201 (the outer wall of the lock hole), the return spring 502 is compressed; the engaging block 503 located on the return tongue 501 cooperates with the triggering rod 306 of the bearing 302; when the return tongue 501 is in the high position, the engaging block 503 is located on an upper end of the triggering lever 306, which does not affect the movement of the trigger lever 306. It can be understood that the shape of the return tongue 501 can also be configured in other structures. For example, the lower end of the return tongue 501 can also fall on the engaging board 204 to move upwards with the engaging board 204, or the return tongue 501 is located at a rear end of the outer wall of the handle 201. When the handle is closed in the lock body base 101, the return tongue 501 is pushed backward to compress the return spring 502, and the engaging block 503 is released from contact with the triggering lever 306 of the bearing 302. After the handle 201 is opened, the return spring 502 pushes the return tongue 501 to move forward, the engaging block 503 then pushes the triggering lever 306 to move downward. For this respect, all other implementation ways of structures of the return tongue 501 obtained by persons of ordinary skill in the art without creative efforts shall fall within the protection scope of the present disclosure.

It can be seen that the electronic cabinet lock shown in the figures further includes a control circuit board 401 and a tact switch 402 attached on the control circuit board 401 with a contact spring 403. The triggering lever 306 on the bearing 302 extending along the engaging ring 305 is located at a lower end of the contact spring 403, and the triggering lever 306 does not trigger the contact spring 403. It can be understood that the contact spring 403 of the tact switch 402 shown in the figure is used to detect the displacement of the triggering lever 306 and the triggering lever 306 is fixed on the bearing 302 directly reflecting the movement of the bearing 302. The bearing 302 reflects the movement of the engaging board 204, and the movement of the engaging board 204 reflects the movement of the unlocking structure. The tact switch 402 is used for sensing the unlocking operation performed by using the unlocking structure. The inductive switch senses the lifting movement of the engaging board 204, or senses the upward movement of the bearing 302, or senses upward movement of the return tongue 501 pushed by the engaging board 204, or senses insertion of the unlocking key, or rotation of the lock core 202 or knob on the handle 201, or action occurs when pressing the button; according to the above actual situation, the inductive switch can also be formed of electromagnetic inductive switch, or touch switch, or micro switch. For this respect, all belong to the protection scope of the present disclosure.

It can be understood that the electromagnet with the self-holding function shown in the figures can also have other similar configurations; for example, the bearing spring 304 is replaced by a second permanent magnet, the second permanent magnet is mounted on the bearing 302, and the bearing 302 is made of non-magnetic-conductive material; when the bearing 302 extends, the second permanent magnet and the first permanent magnet 303 repel each other, when the bearing 302 moves upward, the second permanent magnet and the first permanent magnet 303 magnetically repel each other to keep the downward force on the bearing 302; when the bearing 302 continues to move upwards and beyond the first permanent magnet 303, the bearing 302 is attracted with the first permanent magnet 303, and the bearing 302 is kept in a retracting state while the electromagnetic coil 301 is de-energized; when the electromagnetic coil 301 is energized reversely, a magnetic repulsive force generated by the electromagnetic coil on the second permanent magnet is greater than the magnetic attractive force generated by the first permanent magnet 303 on the second permanent magnet, to force the second permanent magnet to move downward, and thereby the bearing 302 extends; when the bearing 302 extends, after the electromagnetic coil 301 is energized forwardly, the magnetic attractive force by the electromagnetic coil generated on the second permanent magnet is greater than magnetic repulsive force generated by the first permanent magnet 303 on the second permanent magnet, so that the second permanent magnet moves upward and the bearing 302 thereby retracts. For this respect, all belong to the protection scope of the present disclosure.

It can be understood that the bearing 302 and the engaging boss 205 shown in the figure are configured such that the engaging boss 205 located at the rear end of the bearing 302 are engaged with the bearing 302 after the bearing 302 falls into the concave slot 206 in the engaging boss 205 to cause the engaging board 204 not to move outward, and thus the handle 201 is controlled not to be disengaged from the lock body base 101. There may be various ways of similar configuration of the bearing 302 and the engaging boss 205, for example, the lower end of the bearing 302 is a hollow hole, the engaging boss 205 is located in the hollow hole of the bearing 302, such configuration can also achieve the above effect. All other implementation ways of the bearing 302 and the engaging boss 205 obtained by persons of ordinary skill in the art without creative efforts shall fall within the protection scope of the present disclosure.

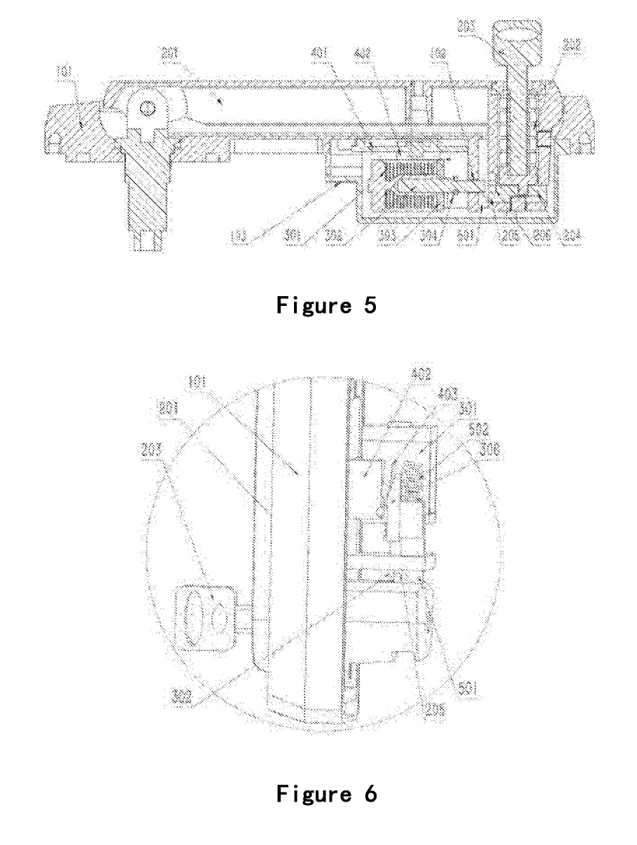

FIG. 5 is an internal schematic sectional view of the electronic cabinet lock in the present disclosure when the state of the electronic cabinet lock is changed from a closed state to a unlocked state; it can be understood that when the electromagnetic coil 301 is energized forwardly, a magnetic attractive force generated by the electromagnetic coil 301 on the bearing 302 or on the second permanent magnet causes the bearing 302 to move upward, and to be detached from the snap-fitting state with the engaging board 204, then the handle 201 can be opened.

FIG. 6 is a partial internal schematic view of the electronic cabinet lock in the present disclosure when the bearing 302 is pushed into a retracting state; it can be seen in the figure that the mechanical key 203 is inserted into the lock core 202 and drives the engaging board 204 to move upward by rotating the lock core 202. The engaging board 204 pushes the bearing 302 to move upward and the bearing spring 304 is compressed.

At this time, it can be seen that the triggering lever 306 on the bearing 302 has triggered the spring leaf of the tact switch 402, and the control circuit board 401 then can obtain the triggering information of the tact switch 402. It can be understood that the purpose of the tact switch 402 is primarily to detect the unlocking action. Initially, when the electronic cabinet lock is closed, the inductive switch is triggered. The process of the inductive switch which is released with the unlocking operation can also be obtained by the control circuit board 401 as triggering information. For this respect, all belong to the protection scope of the present disclosure.

If the electromagnetic coil 301 is energized reversely or kept being energized reversely, the electromagnetic coil 301 and the first permanent magnet 303 magnetically offset each other, and the bearing 302 is subjected to a downward pushing force by the bearing spring 304 in a compressed state. Relevant schematic views are shown in FIGS. 2, 3, 4; it can be seen from the figures that rotating the key drives the lock core 202 to be rotated so that the engaging board 204 is lowered, the bearing 302 descends and is still engaged with the engaging board 204, so that the handle 201 cannot be detached from the lock body base 101.

At this time, the triggering lever 306 has disengaged from contact with the contact spring 403 of the tact switch 402 as the bearing 302 descends. It can be understood that in this process, the bearing 302 is subjected to a downward force after the electromagnetic coil 301 is energized reversely, and the electromagnetic coil 301 can still remain energized reversely after the inductive switch returns to the previous non-triggered state, and the bearing 302 is kept receiving a downward force; of course, it is also possible to turn off the electromagnetic coil 301 after the inductive switch returns to the previous non-triggered state, and the bearing 302 will remain in the extending state. For this respect, all belong to the protection scope of the present disclosure.

While in FIG. 6, if it is determined that the unlocking operation is legal or when malfunction occurs in the control circuit board 401 of the electronic cabinet lock or the electronic cabinet lock itself fails, the bearing 302 in the retracting state will be affect by the first permanent magnet 303 and maintain the retracting state when the electromagnetic coil 301 is de-energized; schematic views of the related drawings can be referred to as shown in FIG. 5. It can be understood that when the lock core 204 is rotated by rotating the key so that the engaging board 204 is lowered, the engaging board 204 is disengaged from the snap-fitting state with the bearing 302 which is still in the retracting state, the bearing 302 loses control to the engaging board 204, and the handle 201 can be detached from the lock body base 101.

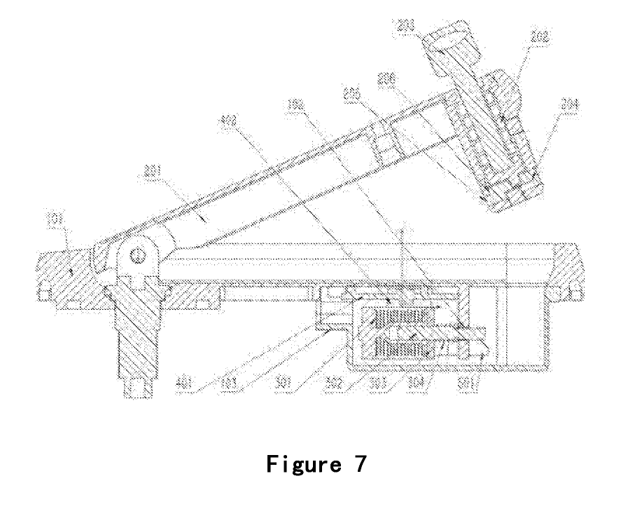

FIG. 7 is an internal schematic view of the electronic cabinet lock in the present disclosure after the handle 201 of the electronic cabinet lock is detached from the lock body base 101. It can be seen from the figure, after the handle 201 is detached from the lock body base 101, the lower end of the return tongue 501 is disengaged from the outer wall of the handle 201, and the outer wall of the handle 201 releases blocking for the return tongue 501. At this time, the return spring 502 in the compressed state pushes the return tongue 501 to move downward, and the engaging block 503 on the return tongue 501 drives the engaging ring 305 to move downward so that the bearing 302 moves downward, the bearing 302 is converted into the extending state, and the return spring 502 returns to the stretching state. At this moment, the bearing 302 is transformed to the extending state from the retracting state by the action of the return tongue 501 and the return spring 502 without the involvement of the electromagnetic coil 301, thereby preventing the problem that the electronic cabinet lock cannot be locked in the power-off state.

According to the electronic cabinet lock of the present disclosure, the characteristics of the self-holding electromagnet and the ingenious structure of engagement of the bearing 302 and the engaging board 204 will be effectively utilized, and the self-holding electromagnet is adjusted to be capable of long-term power supply, thus the requirements that the electronic cabinet lock can be automatically opened daily and the key can only be used after the electronic cabinet lock system fails are achieved, which is favorable for the popularization and application of the electronic cabinet lock of the present disclosure.

### Embodiment 2: An Electronic Cabinet Lock Control Method

The controlled electronic cabinet lock includes the aforementioned lock base 101, the handle 201, the unlocking structure, the engaging board 204, the self-holding electromagnet (the electromagnetic coil 301, the bearing 302, the first permanent magnet 303, a biasing structure body (bearing spring 304 or a second permanent magnet)).

A1, in the initial state, the electromagnet coil 301 keeps being energized reversely, the electromagnet coil 301, the first permanent magnet 303 and the biasing structure body conjointly hold a downward force on the bearing 302 which remains in an extending state and a lowered end of the bearing 302 falls on the slot 206 of the engaging board 204, and is snap-fitted with the engaging board 205 on the upper end of the engaging board 204, the control handle is closed in the lock body base 101, and the electronic cabinet lock is in a closed state;

A2, when the automatic unlocking is needed, the electromagnet coil 301 of the self-holding electromagnet is energized forwardly, and the magnetic attractive force generated by the electromagnet coil 301 on the bearing 302 or on the biasing structure body (for example, the second permanent magnet) located on the bearing 302 causes the bearing 302 to move upwards, the bearing 302 is released from the snap-fitted state with the engaging board 204, the handle 201 is detached from the lock body base 101 and the electronic cabinet lock is automatically opened;

A3, when the engaging board 204 is moved upward by the unlocking structure (unlocking mechanism), the bearing 302 is pushed to move upward, and the bearing 302 is transformed from the extending state to the retracting state.

A4, after step A3, if the electromagnet coil 301 is de-energized or energized forwardly, the bearing 302 is kept in the retracting state and released from the snap-fitting state with the engaging board 204 by the action of the permanent magnet 303 when the engaging board 204 moves downward, and the handle 201 is detached from the lock body base 101, and the electronic cabinet lock is opened;

A5, after step A3, if the electromagnet coil 301 still keeps being energized reversely, the electromagnet coil 301, the first permanent magnet 303 and the biasing structure body conjointly hold a downward force on the bearing 302, when the engaging board 204 is moving downward, the bearing 302 moves downward with the engaging board 204 and remains in a snap-fitting state, the handle 201 is still closed in the lock body base 101, and the electronic cabinet lock cannot be opened;

It can be understood that the electronic cabinet lock does not include an inductive switch, and here one does not need to consider the power consumption problem when the electronic cabinet is closed. As long as the electromagnetic coil 301 is always energized reversely when the electronic cabinet lock is in a closed state, the purpose of preventing illegal unlocking can be achieved.

### Embodiment 3: An Electronic Cabinet Lock Control Method

The difference between this embodiment and Embodiment 2 lies in that the electronic cabinet lock includes a return tongue 501 and a return spring 502, and the control method includes:

B1, in the initial state, the electromagnet coil 301 keeps energized reversely, the electromagnet coil 301, the first permanent magnet 303 and the biasing structure body conjointly hold a downward force on the bearing 302 which remains in an extending state, and a lowered end of the bearing 302 falls on the slot 206 of the engaging board 204, and is snap-fitted with the engaging boss 205 on the upper end of the engaging board 204, the control handle 201 is closed in the lock body base 101, and the electronic cabinet lock is in a closed state; the lower end of the return tongue 501 falls on the outer wall of the handle 201 or the engaging board 204, the return spring 502 is compresses.

B2, when the automatic unlocking is needed, the electromagnet coil 301 of the self-holding electromagnet is energized forwardly, and the magnetic attractive force generated by the electromagnet coil 301 on the bearing 302 or the biasing structure body located on the bearing 302 causes the bearing 302 to move upwards, the bearing 302 is released from the snap-fitting state with the engaging board 204, the handle 201 is detached from the lock body base 101 and the electronic cabinet lock is then automatically opened;

B3, when the engaging board 204 is moved upward by the unlocking structure, the bearing 302 is pushed to move upward, and the bearing 302 is transformed from the extending state to the retracting state;

B4, if the electromagnet coil 301 is de-energized or energized forwardly, the bearing 302 is kept in the retracting state and released from the snap-fitting state with the engaging board 204 by the action of the permanent magnet 303 when the engaging board 204 moves downward, and the handle 201 is detached from the lock body base 101, and the electronic cabinet lock is opened;

B5, if the electromagnet coil 301 still keeps being energized reversely, the electromagnet coil 301, the first permanent magnet 303 and the biasing structure body conjointly hold a downward force on the bearing 302, when the engaging board 204 moves downward, the bearing 302 moves downward with the engaging board 204 and remains in a snap-fitting state, the handle 201 is still closed in the lock body base 101, and the electronic cabinet lock cannot be opened;

B6, after/when the handle 201 is detached from the lock body base 101, the lower end of the return tongue 501 is detached from the outer wall of the handle 201 or the engaging board 204, the return tongue 501 is pushed by the return spring 502 to perform a downward movement, the return tongue 501 pushes the bearing 302 in the retracting state to move downward against the magnetic attractive force of the first permanent magnet, the bearing 302 extends and remains in an extending state;

B7, when the state of electronic cabinet lock is changed from “opened” to “closed”, the handle 201 is pushed into the lock body base 101, the outer wall of the handle 201 or the engaging board 204 pushes the return tongue 501 to move upward and the return spring 502 is compressed, and the bearing 302 is held in the extending state by the biasing structural body and snap-fits with the engaging board 204, the electronic cabinet lock is closed.

It can be understood that, compared with the embodiment 2, the electronic cabinet lock includes a return tongue 501 and a return spring 502. In the control method, when the electronic cabinet lock is unlocked and the electromagnetic coil 301 is de-energized, under the action of the return tongue 501 and the return spring 502, the bearing 302 can be transformed from the retracting state to the extending state to ensure that the electronic cabinet lock can still be used as a mechanical lock when the control circuit board 401 or the power supply system fails, and thus the electronic cabinet lock can be locked, which provides more practical significance for application compared with the second embodiment.

### Embodiment 4: An Electronic Cabinet Lock Control Method

A difference from Embodiment 2 and Embodiment 3 lies in that the electronic cabinet lock further includes an inductive switch installed in the lock body base 101 for sensing the unlocking operation performed by using the unlocking structure. The control method includes:

C1, in the initial state, the electromagnet coil 301 keeps being energized reversely or de-energized, the bearing 302 keeps extending and a lowered end of the bearing 302 falls on the slot 206 of the engaging board 204, and is snap-fitted with the engaging boss 205 on the upper end of the engaging board 204, the control handle 201 is closed in the lock body base 101, and the electronic cabinet lock is in a closed state;

C2, when the automatic unlocking is needed, the electromagnet coil 301 of the self-holding electromagnet is energized forwardly, and the magnetic attractive force generated by the electromagnet coil 301 on the bearing 302 or on the biasing structure body located on the bearing 302 causes the bearing 302 to move upwards, the bearing 302 is released from the snap-fitting state with the engaging board 204, the handle 201 is detached from the lock body base 101 and the electronic cabinet lock is automatically opened;

C3, when the engaging board 204 moves upward by the unlocking structure, the bearing 302 is pushed to move upward, and the bearing 302 is transformed from the extending state to the retracting state; at this time the inductive switch is triggered;

C4, if the electromagnet coil 301 is de-energized when it is determined that it is a legal unlocking operation (mechanical unlocking operation performed when power is off, Internet is off or equipment malfunction occurs (malfunction of control circuit board of the electronic cabinet lock, or the electronic cabinet lock failure itself), or when malfunction occurs in the control circuit board 401 of the electronic cabinet lock or the electronic cabinet lock itself fails, the bearing 302 is kept in the retracting state and released from the snap-fitting state with the engaging board 204 by the action of the permanent magnet 303 when the engaging board 204 moves downward, and the handle 201 is detached from the lock body base 101, and the electronic cabinet lock is opened;

C5, the electromagnet coil 301 is energized reversely or still keeps being energized reversely when it is determined that it is an illegal mechanical unlocking operation performed, the electromagnet coil 301, the first permanent magnet 303 and the biasing structure body conjointly hold a downward force on the bearing 302, when the engaging board 204 moves downward, the bearing 302 moves downward with the engaging board 204 and remains in a snap-fitting state, the handle 201 is still closed in the lock body base 101, and the electronic cabinet lock cannot be opened;

It can be understood that embodiment 4 is different from embodiments 2 and 3 in that an inductive switch for sensing the unlocking operation performed by using the unlocking structure is added in the electronic cabinet lock. Compared with the electronic cabinet lock control methods in embodiments 2 and 3, in the electronic cabinet lock control method in the present embodiment, it is only necessary for the electromagnetic coil 301 to be powered during the illegal unlocking, so that the power consumption of the electronic cabinet lock can be reduced when the electronic lock is locked, and the hidden dangers that the electromagnetic coil 301 may be burned due to excessive heat after being powered on for a long time can be eliminated, so as to avoid damage of the electromagnetic coil 301 caused by prolonged power supply, thereby reducing the probability of electronic cabinet lock failure. With a higher practical value, it is more conducive for popularization and application of the present disclosure.

The present disclosure provides an electronic cabinet lock and a control method thereof, of which the electronic cabinet lock has a simple and reliable structure and the principle of the control method is clear. The disclosure utilizes the self-holding electromagnet with the characteristics of maintaining the state of the bearing 302 after power-off, and the snap-fitting between the bearing 302 and the engaging board 204 to achieve the function of a new electronic cabinet lock that the electronic lock can be automatically opened daily, and the key can only be used for unlocking in the event of lock malfunction, the current technical requirements of the market for the electronic lock can be fully met, and the present disclosure has a high promotional value.

However, the foregoing descriptions are merely preferred embodiments of the present disclosure and are not intended to limit the protection scope of the present disclosure. All equivalent structural changes made using the contents of the specification and accompanying drawings of the present disclosure are included in the protection scope of the present disclosure.

For example, in the above embodiment, the electronic lock core is a purely mechanical lock core. However, the present disclosure is not limited to this. For example, the electronic lock core may be an electronic lock core with a chip, an electric control structure such as an electromagnet or a motor inside the lock core, and this structure will be completely independent of the other structures (self-holding electromagnet, etc.) inside the lock body.

1. An electronic cabinet lock, comprising a lock body base, a handle, an unlocking mechanism, an engaging board, a self-holding electromagnet,
one end of the handle is movably connected to the lock body base, the other end of the handle is attached with the unlocking mechanism and the engaging board which moves under control of the unlocking mechanism,
the self-holding electromagnet is mounted on the lock body base,
wherein
the self-holding electromagnet comprises an electromagnetic coil, a retractable body, a first permanent magnet, and a biasing structure body,
the retractable body is disposed in a hole for movement of the retractable body of the electromagnetic coil, when the electromagnetic coil is energized forwardly, the retractable body can be driven to perform a retracting operation or the biasing structure body can be driven to drive the retractable body to perform a retracting operation, when the electromagnetic coil is energized reversely, the retractable body can be driven to perform an extending operation or the retractable body can be driven by the electromagnetic coil and the biasing structure body to perform an extending operation, when the electromagnetic coil is de-energized, the retractable body remains in an extending state or a retracting state,
the engaging board is controlled by the unlocking mechanism to move in a retractable direction of the retractable body,
a mutual snap-fit between the retractable body and the engaging board is realized by movement of the retractable body and the engaging board towards each other in the retractable direction and is released by movement of the retractable body and the engaging board away from each other in the retractable direction,
the first permanent magnet is configured to maintain the retracting state when the retractable body retracts, the biasing structure body bias the retractable body, in order to maintain the extending state when the retractable body extends.

2. The electronic cabinet lock as claimed in claim 1, wherein the unlocking mechanism is an unlocking key, a lock core, a knob or a button; and the movement of the engaging board controlled by the unlocking mechanism refers to up and down movement of the engaging board controlled by the unlocking operation of the mechanical unlocking key, the lock core, the knob, or the button.

3. The electronic cabinet lock as claimed in claim 2, wherein the biasing structure body is a retractable body spring or a second permanent magnet; in a case where the biasing structure body connecting with the retractable body is a retractable body spring connecting with the retractable body, the retractable body spring exerts a downward force on the retractable body when the retractable body is in the retracting state, in this case, the retractable body is made of a material which can be magnetically attracted; in a case where the biasing structure body connecting with the retractable body is the second permanent magnet attached on the retractable body, the second permanent magnet repels the magnetism of the first permanent magnet when the retractable body is in the extending state, the retractable body is maintained in the extending state, when the second permanent magnet moves upward with the retractable body to a retracting state, the second permanent magnet generates a magnetic attractive force to the first permanent magnet with displacement relative to the first permanent magnet, so as to keep the retractable body in a retracting state.

4. The electronic cabinet lock as claimed in claim 3, wherein the electronic cabinet lock further comprises a return tongue and a return spring which are mounted in the lock body base, a lower end of the return tongue abuts against an outer wall of the handle or engaging board, when the handle is closed in the lock body base, the return spring is compressed or stretched; the return tongue cooperates with the retractable body, and when the retractable body is in a high position and the handle is detached from the lock body base, the return spring pushes the return tongue to cause the retractable body to move downward.

5. The electronic cabinet lock as claimed in claim 3, wherein the electronic cabinet lock further comprises an inductive switch attached in the lock body base for sensing the unlocking operation performed by using the unlocking mechanism; the inductive switch is a tact switch, an electromagnetic inductive switch, a contact switch, or a micro switch; the inductive switch is configured to sense the unlocking operation performed by using the unlocking mechanism, which means that said inductive switch senses lifting movement of the engaging board, or senses upward movement of the retractable body, or senses motion occurs when inserting the unlocking key, turning the lock core or knob of the handle or pushing down the button.

6. The electronic cabinet lock as claimed in claim 5, wherein said inductive switch senses lifting movement of the engaging board, or senses upward movement of the retractable body, which refers to that the inductive switch is triggered by the return tongue raised with the engaging board or the triggering rod of the retractable body triggers the inductive switch as it rises with rising of the retractable body.

7. The electronic cabinet lock as claimed in claim 5, wherein the electronic cabinet lock further comprises a control circuit board; the control circuit board is connected with the electromagnetic coil and is responsible for performing forward or reverse power supply to the electromagnetic coil; the control circuit board is connected with the inductive switch and is responsible for receiving signal of the inductive switch,
the control circuit board determines whether or not the operation of the unlocking mechanism is an illegal unlocking operation when the mechanical unlocking machine is actuated to trigger the inductive switch, and if it is determined that the unlocking operation is an illegal unlocking operation, the electromagnetic coil is energized reversely, if it is determined that the unlocking operation is a legal unlocking operation, the electromagnetic coil is energized forwardly or de-energized.

8. The electronic cabinet lock as claimed in claim 1, wherein the retractable direction is an up-and-down direction, an upper end of the engaging board is provided with an engaging boss fitting with the retractable body, and when the electronic cabinet lock is in a closed state, a lower end of the retractable body in the extending state falls on the engaging boss and is supported by the engaging boss, and mutually snap-fitting with the engaging boss.

9. An electronic cabinet lock control method for controlling the electronic cabinet as claimed in claim 1,
wherein the electromagnetic coil remains being energized reversely when the electronic cabinet lock is in a closed state; the electromagnetic coil of the self-holding electromagnet is energized forwardly when there is a need of automatic unlocking.

10. An electronic cabinet lock control method for controlling an electronic cabinet lock as claimed in claim 5,
wherein the electromagnetic coil remains being energized reversely or in a de-energized state when the electronic cabinet lock is in a closed state;
the electromagnetic coil is energized forwardly when there is a need of automatic unlocking;
in a case where the electronic cabinet lock is in a closed state, when the engaging board moves upward through the unlocking mechanism, the inductive switch is triggered, in this case it is determined whether the action of the unlocking mechanism is an illegal unlocking operation, if it is determined that the action is a legal unlocking operation, the electromagnetic coil is energized forwardly or de-energized when the engaging board moves downward; if it is determined that the action is an illegal unlocking operation, the electromagnetic coil is energized reversely or maintains being energized reversely.

11. The electronic cabinet lock control method as claimed in claim 10, wherein the legal unlocking operation comprises unlocking operation performed by the unlocking mechanism when a network interruption or equipment malfunction occurs, or when the electronic cabinet lock obtains a legal unlocking authorization.

12. The electronic cabinet lock as claimed in claim 4, wherein the electronic cabinet lock further comprises an inductive switch attached in the lock body base for sensing the unlocking operation performed by using the unlocking mechanism; the inductive switch is a tact switch, an electromagnetic inductive switch, a contact switch, or a micro switch; the inductive switch is configured to sense the unlocking operation performed by using the unlocking mechanism, which means that said inductive switch senses lifting movement of the engaging board, or senses upward movement of the retractable body, or senses upward movement of the return tongue pushed by the engaging board, or senses motion occurs when inserting the unlocking key, turning the lock core or knob of the handle or pushing down the button.

13. The electronic cabinet lock control method as claimed in claim 10, wherein the unlocking mechanism is a mechanical unlocking key, a lock core, a knob or a button; and the movement of the engaging board controlled by the unlocking mechanism refers to up and down movement of the engaging board controlled by the unlocking operation of the mechanical unlocking key, the lock core, the knob, or the button.

14. The electronic cabinet lock control method as claimed in claim 11, wherein the biasing structure body is a retractable body spring or a second permanent magnet; in a case where the biasing structure body connecting with the retractable body is a retractable body spring connecting with the retractable body, the retractable body spring exerts a downward force on the retractable body when the retractable body is in the retracting state, in this case, the retractable body is made of a material which can be magnetically attracted; in a case where the biasing structure body connecting with the retractable body is the second permanent magnet attached on the retractable body, the second permanent magnet repels the magnetism of the first permanent magnet when the retractable body is in the extending state, the retractable body is maintained in the extending state, when the second permanent magnet moves upward with the retractable body to a retracting state, the second permanent magnet generates a magnetic attractive force to the first permanent magnet with displacement relative to the first permanent magnet, so as to keep the retractable body in a retracting state.

15. The electronic cabinet lock control method as claimed in claim 12, wherein the electronic cabinet lock further comprises a return tongue and a return spring which are mounted in the lock body base, a lower end of the return tongue abuts against an outer wall of the handle or engaging board, when the handle is closed in the lock body base, the return spring is compressed or stretched; the return tongue cooperates with the retractable body, and when the retractable body is in a high position and the handle is detached from the lock body base, the return spring pushes the return tongue to cause the retractable body to move downward.

16. The electronic cabinet lock control method as claimed in claim 13, wherein the retractable direction is an up-and-down direction, an upper end of the engaging board is provided with an engaging boss fitting with the retractable body, and when the electronic cabinet lock is in a closed state, a lower end of the retractable body in the extending state falls on the engaging boss and is supported by the engaging boss, and mutually snap-fitting with the engaging boss.
